(19) United States
(12) Patent Application Publication
(10) Pub. No.: US 2011/0185979 A1
(43) Pub. Date: Aug. 4, 2011

(54) MOBILE HORSE EXERCISE AND HYDROTHERAPY SYSTEM

(75) Inventor: Mark A. Dunagan, Louisville, KY (US)

(73) Assignee: EQUINE AQUATIC CARE, LLC, Louisville, KY (US)

(21) Appl. No.: 12/696,278

(22) Filed: Jan. 29, 2010

Related U.S. Application Data
(60) Provisional application No. 61/149,935, filed on Feb. 4, 2009.

(51) Int. Cl. A61H 33/00; A01K 15/02

(52) U.S. Cl. 119/703; 119/702

(57) ABSTRACT

An apparatus in the form of a mobile system for delivery and administration of exercise, conditioning, and hydrotherapeutic massage of horses, including thoroughbred race horses, comprising a tank containing a pool of water, a self-contained, mobile structure for holding the pool of water, a self-contained, mobile reservoir or reserve tank for quickly filling the tank containing the pool of water, a system for transfer of water from the reserve tank into the tank containing a pool of water and vice versa, a plurality of current inducing jets, a plurality of water massage jets, a lift device for raising or lowering the horse into the pool, an outlet for rapidly discharging the contents of the filled tank containing the pool of water and pumps of a sufficient power to induce a current within the tank.

An apparatus for exercising and massaging a horse comprising a tank or chamber containing water, a plurality of water jets in the face of one wall of the tank or chamber, an adjustable flow control for the water jets inducing the current, a plurality of water massage jets in opposing sidewalls of the tank or chamber, an adjustable flow control for the water massage jets, apparatus for lowering or raising the animal from the tank.

### PRIOR ART STATEMENT AND BACKGROUND OF THE INVENTION

This invention relates to the field of aquatic exercise, conditioning and therapeutic convalescence of horses, most particularly thoroughbred horses.

It is widely accepted that horses are capable of swimming, however, many horse are not able swimmers. Invariably, attempting to swim a horse not inclined for this activity may result in the drowning of that horse. Further, it is known that aquatic conditioning of horses is advantageous as swimming is a non-impact exercise which trains muscles without the stress on the animal's bones, joints, tendons and ligaments that is commonly associated running. Resistance training in water aerobically conditions a horse, further expanding the benefits to a racehorse. In addition, the longevity of a race horse can be increased through aquatic training without further deterioration of limbs and joints. Lastly, a young horse not ready for riding can be trained without risk to less than fully developed bones, joints, etc.

Therapeutic massage using hydrojets is widely recognized as an aid to stimulate circulation within the muscles of the trained horse. This hydrotherapy is known to reduce the recovery time of injured horses and to speed the healing of sore horses.

A drawback to existing technology for swimming horses is that, due to the size of the animal desired to be conditioned aquatically, the size of the pool necessary to accommodate the animal has been generally limited to large, fixed and usually in-ground pools or natural bodies of water. To this end, the existing technology for swimming a horse is deficient in that the horse must be delivered to the pool or body of water, although the prior art discloses portable devices employing submerged treadmills for application of water-resistance to running in water.

Also, since the swimming pools are generally fixed and immobile, the horse must be delivered to the pool for the aquatic exercise. In situations where an animal is injured, the additional travel required to aquatically condition the animal may exacerbate the injury.

Aside from these problems, the use of a pool per se has serious drawbacks. If the horse is to have an area large enough to swim, the size of such a pool requires a significant amount of space, and the pumping, filtering and heating requirements for keeping the pool properly clean and heated are significant. Secondly, due to the size of the pools, a significant volume of water is required to fill the pool. Often, the animal, upon introduction to the water, either defecates and/or urinates in the water creating a sanitary issue. In such pools, the water is reused which requires significant filtration and sanitized using harsh chemicals to counteract the biological contaminants.

The prior art is also limited with regard to effective appliances and methods for ensuring the safety of the horse while in the pool or body of water. Often these devices are expensive and employ complicated hoists which also tend to frighten the horse. Further still, the rigid structure of fixed pools used to swim horses inherently. ‘trap’ the horse in the pool and force the horse to exit the pool in emergency situations either through the same approach used for the horse's entry into the pool or through an exit at the opposite end of the pool, often a considerable distance away. As horses are sensitive to being frightened by new experiences, if a horse becomes startled during its entry into a pool, the sheer size of the animal, the inherent danger of drowning, and the pecuniary value of the animal makes swimming thoroughbred horses a substantial risk to the horse and the owner.

From the prior art, one form of exercise facility is illustrated by U.S. Pat. No. 3,691,995, granted to Glen Melvon Litte, on Sep. 19, 1972. This patent describes a fixed pool in the form of a circular configured center portion having a sloping ramp portion providing ingress and egress of said tank and an island in the center of the pool thereby creating an annular-shaped pool. The patent describes access to the island in the middle of the tank through counterbalanced pedestrian bridges linking the island with the pool perimeter. The method describes leading a horse down the sloping ingress to the annular shaped pool where the person leading the horse crosses the bridge to the island in the center of the pool. From there, a horse is directed to swim around the annular shaped pool while the handler walks about the island thereby leading the horse to swim in circles for the desired period of time.

A second form of exercise facility in the prior art is illustrated by U.S. Pat. No. 7,086,994, granted Aug. 8, 2006 to John A. Turak and Anson J. Flake. This patent describes a fixed pool containing a submerged treadmill, a plurality of water massage jets as well as a current inducing water jets. The method describes the use of the pool by a human subject for the alternate or combined purpose of aquatic exercise, either swimming or running on the submerged treadmill, or hydrotherapeutic massage. The patent describes entrance and exit by the user under its own power through the use of steps on one side of the pool.

Another form of exercise facility in the prior art is illustrated by U.S. Pat. No. 4,197,815, granted Apr. 5, 1980, to Carl L. Brazelton. This patent describes a fixed pool containing entrance ramp declining into rectangular segment of the pool which leads to an inclining exit ramp at base level. It describes the induction of current in the water leaving from the sides of the exit ramp across the rectangular segment of pool to the entrance ramp. The method is described that the operator shall lead the horse down the entrance ramp into the pool where the horse must swim against the current to reach the other side of the pool and ultimately exit the pool. The patent is silent as to any features for removal of the animal from the pool under emergency situations.

Another form of exercise facility in the prior art is illustrated by U.S. Pat. No. 4,918,766, granted Apr. 24, 1990, to Angelo Leonaggeo, Jr. This patent describes a fixed pool containing a submerged treadmill appliance that can be raised or lowered to adjust the level of submersion of the subject in the water pool. The patent also includes a plurality of water massage jets located in the sidewalls of the pool which are used for the induction of water-turbulence massage on the subject animal. U.S. Pat. No. 4,574,739, granted Mar. 11, 1986, to Lucien P. Fontaine and Angelo Leonaggeo, Jr. describes a forerunner to the '766 patent which also employs a submerged treadmill, vertically adjusted for accommodation of the horse into the exercise pool.

Lastly, both U.S. Pat. No. 4,165,714, granted Aug. 28, 1979, to Jerry Weissman and Ely Kass, and U.S. Pat. No. 4,236,489, granted Dec. 2, 1980, to James Carra describe overhead apparatuses for lifting large animals into and out of pools of water. Both feature platforms upon which the animal is directed to stand with employment of features to lift the platforms with the animals in place. Both patents similarly feature pools below the lifting devices described in '489 as a “horse conditioning pool” and in '714 as a “hydrotherapeutic tank”. The patents describe the pools as employing “water jets” and “hydrotherapeutic jet nozzles,” respectively. The '489 also describes the use of the horse conditioning pool for “swimming-in-place.”

### SUMMARY OF THE INVENTION

The present invention is a mobile horse exercise and hydrotherapy system which is easily transported and is safe and effective for the horse to train or to recover from injury or soreness. The system is built on a flat-bed trailer permitting the unit to be transported to the horse. This feature foregoes any risk associated with transporting the horse to a below-ground pool deep enough to accommodate swimming a horse.

Horses can swim by instinct. Swimming is a safe and effective no-impact exercise for injured horses that cannot use water treadmills. There is no impact to the bones, tendons, or joints of horses when swimming. Swimming also improves cardiovascular fitness, stamina, and muscle tone. The water naturally increases resistance and forces the muscles to work harder in the water than on land. In addition, the resistance provided by nozzles or jets inducing a current in the swim chamber can be controlled to increase the intensity of the conditioning session.

The most positive aspect of hydrotherapy, most specifically, swimming, is that a horse otherwise unable to do any conditioning work at all (perhaps due to injury) can be trained to almost total fitness and this training can be achieved without concussing an existing injury. Swimming also provides great resistance training, even for a sound horse. Furthermore, swimming is a strenuous workout for most horses which works muscles in a manner altogether dissimilarly than standard track conditioning.

In addition, the invention provides a minimally restrictive means for safely exercising the horse in the water while simultaneously providing support to the horse while in the in the tank. In the event of an emergency, the invention permits rapid evacuation of the water from the tank through a safety release valve, which coupled with the relatively small swim chamber, minimizes risk to animal and owner. And since the volume of water used in the swim chamber is much less 150 than similar types of equine hydrotherapy devices, the water can be exchanged if desired for hygienic needs.

Lastly, the swim chamber has been fitted with water jets or nozzles which permit the invention to be employed as a hydrotherapeutic spa for water massage of sore or injured horses. This integration of the aforementioned applications into a mobile unit capable of making ‘housecalls’ to equine farms results in a significant advance in the field of equine aquatic care.

This invention, in its exemplary embodiment, discloses a portable pool, with attendant reservoir, that can be installed and operated on nearly any flat, open area. Within the swim tank of the invention, a horse can be aquatically conditioned to swim against an artificially induced current. The operator can control the intensity of the current, and therefore the intensity, of the horse's conditioning workout. Further, the invention can deliver a non-impact workout since the horse is swimming, thereby avoiding injuries commonly associated with high-impact exercise such as running. In the event of an emergency, the water can be rapidly evacuated from the swim chamber. Due the relatively small size of the swim chamber, contaminated water can be replaced easily and frequently.

In addition, the operator can treat a horse to a hydrotherapy session using the preferred embodiment of a water jet system to massage the horse and provide various massages of various intensities for treatment of different muscle groups of the horse. The invention also discloses full control of the intensity of the massage jets enabling the operator to tailor the hydrotherapy of the horse to the situational needs of the horse.

The exemplary embodiment combines the aforementioned improvements into one seamless modular device that would allow for inexpensive construction. In addition, the portability of the invention gives rise to the creation of a service industry, whereby the owner of the invention may deliver the therapeutic services to horse at its location without requiring the end user to purchase the invention.

Accordingly, it would be desirable to a horse owner, trainer, veterinarian, track owner or the like to deliver a mobile hydrotherapy and exercise device to the location of the horse to aquatically exercise, condition or massage either a healthy or sick horse without the expense of ownership of the system.

### BRIEF DESCRIPTION OF THE DRAWINGS

FIG. 1 depicts a plan view of the invention

FIG. 2 depicts an elevation view of the invention

FIG. 3 depicts a split view of the rear of the invention showing extension of the entry ramp

FIG. 4 depicts a horse wearing the swim vest and associated anchor points and lift cords;

FIG. 5 depicts an elevation view of the invention with the positioning of a horse inside the invention with the lift brace assembly at base level;

FIG. 6 depicts an elevation view of the invention with the positioning of a horse inside the invention with the lift brace assembly at raised level;

FIG. 7 and FIG. 8 depict threshold, elevation views of the invention with the positioning of a horse inside the invention and base/raised position of the lift brace assembly;

FIG. 9 depicts the lift brace assembly of the invention

FIG. 10 depicts the lifting assembly and hydraulic lifting cylinders of the invention;

FIG. 11 depicts the positioning of a horse inside the invention;

FIG. 12 shows the invention's pump and motor system connecting swim tank and reserve tank;

FIG. 13 depicts an elevation view of the invention's swim chamber;

FIG. 14 depicts an elevation view one embodiment of the invention and its positioning and configuration of multiple massage jets in the walls of the swim chamber;]

### DETAILED DESCRIPTION OF THE PREFERRED EMBODIMENTS

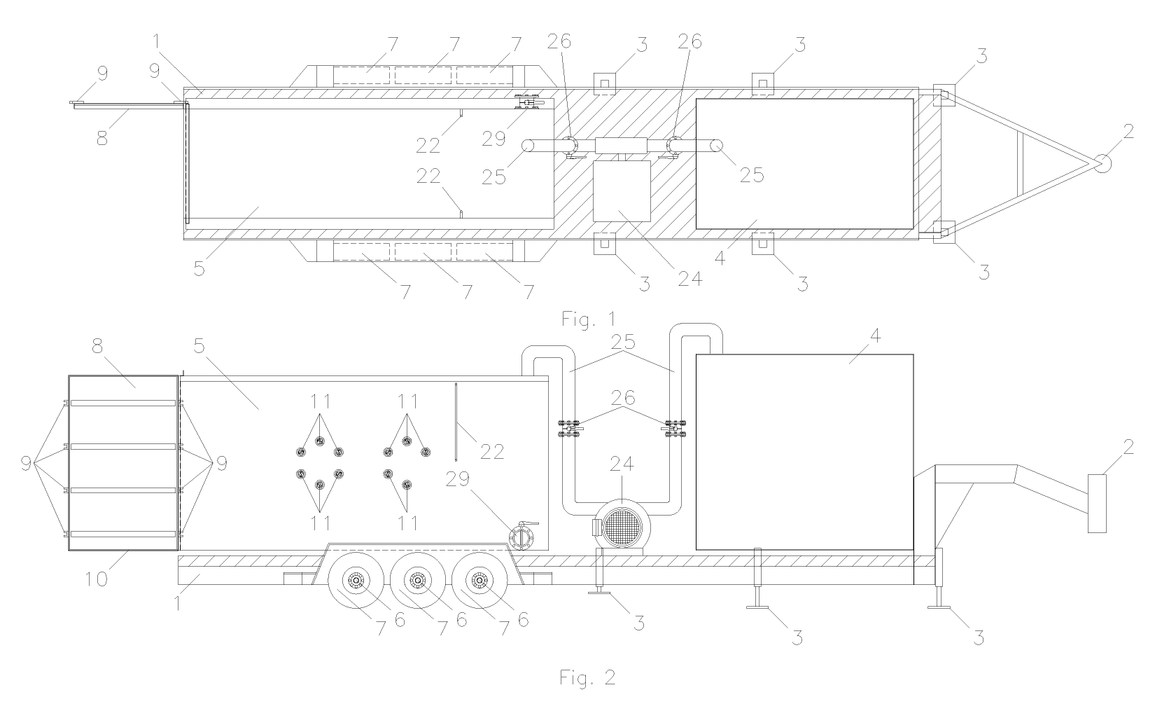

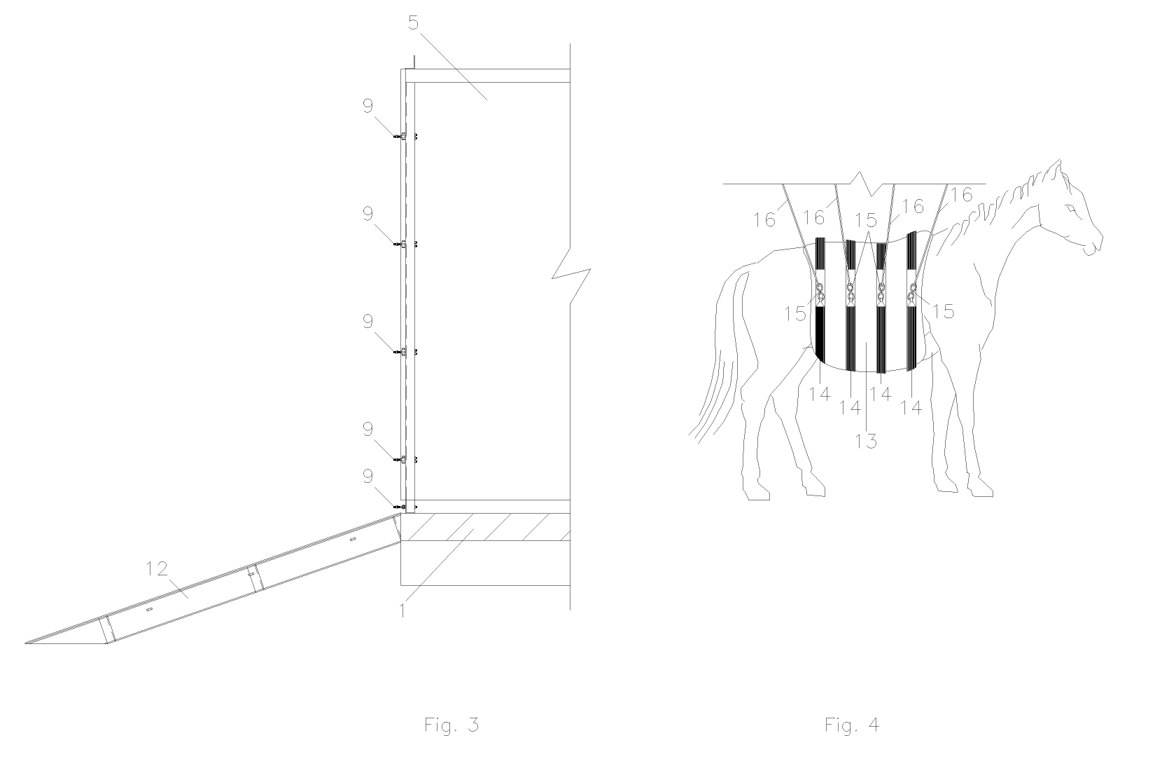

Referring now to FIG. 1, which shows a plan view of the invention, wherein the trailer base 1, a standard trailer hitch 2 for transport by truck, retractable trailer support jacks 3 and the reserve tank assembly 4. FIG. 2 shows an elevation view of the invention, wherein the trailer base 1, trailer support jacks 3, the reinforced swim chamber 5, the three-axels 6, attached trailer wheels 7, reinforced swim chamber door 8, turnbuckles 9, attached door gasket 10, and a plurality of therapeutic water jets 11 are depicted.

The trailer base 1 supports the rest of the equipment. In this exemplary embodiment, the trailer is tri-axle 3, with each axle having a 10,000 pound capacity. Six trailer support jacks 3 located around the perimeter of the trailer may be used to support the weight of the fully loaded trailer—water, horse, etc.

Referring now to FIGS. 1 and 2, the reserve tank assembly 4 is a generally rectangular, cube-like structure with an open top. The reserve tank assembly 4 is placed near one end of the trailer, preferably the end closest to the truck (not pictured). In this exemplary embodiment, the reserve tank assembly 4 can hold approximately 4000 gallons of water during the times a horse is entering or leaving the swim chamber. The exemplary reserve tank assembly 4 is approximately nine feet high, six feet wide, and ten feet long and is made of reinforced aluminum. In a preferred embodiment, the reserve tank assembly 4 includes a filtering system, such as a sock filter, to filter any contamination in the water entering the reserve tank prior to the water being pumped to the swim chamber 5, as further described below.

The swim chamber 5 is a rectangular cube-like structure with an open top. The swim chamber 5 is also placed on and secured to the trailer base 1. In this exemplary embodiment, the swim chamber 5 is approximately eight feet high, five feet wide, and seventeen feet long and made of reinforced aluminum to withstand water pressure and to prevent rusting. The swim chamber 5 includes a reinforced aluminum door 8 approximately five feet wide and eight feet tall and is located at the other end of the trailer base 1 farthest from the truck. In this exemplary embodiment, a rubber gasket 10 approximately one inch wide and one-half inch thick is seated 225 around the outside perimeter of the door 8, so as to prevent the swim chamber 5 from leaking when the door 8 is closed. In this exemplary embodiment, the swim chamber 5 also includes a plurality of turnbuckle lock downs 9 located around the perimeter of the door 8 to ensure a watertight seal when closed. Further, in a preferred embodiment, the door 8 is reinforced with bowed, horizontal beams to accommodate the contained water pressure when the swim chamber 5 is filled with water. A drain valve 29 is proximately located at the aft of the swim chamber 5.

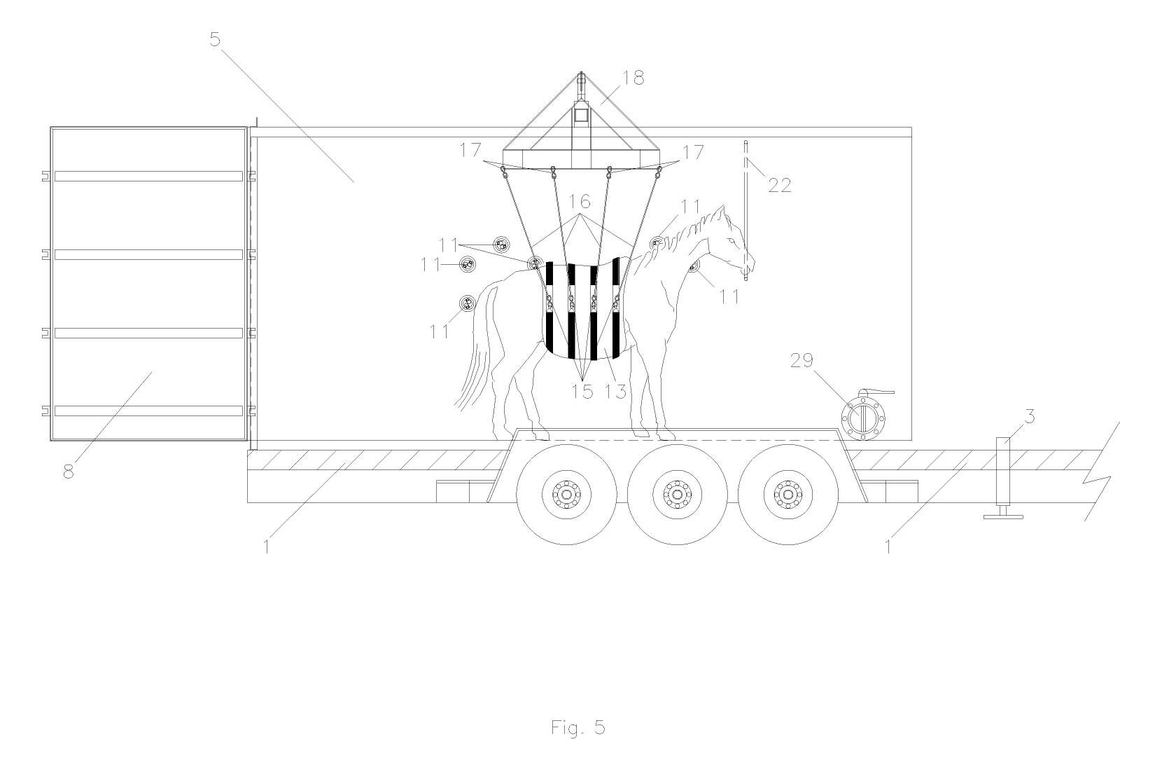

FIG. 3 shows a detailed cut-away of the extreme aft-portion of the invention. Most particularly, FIG. 5 shows the swim chamber 5, the plurality of turnbuckle lockdowns 9, and the integrated ramp 12 extended for use to enter the swim chamber 5 as it rests on the trailer platform 1. This integrated ramp 12 allows a horse to walk in and out of the swim chamber 5. When not in use, the ramp 12 can be flipped up and secured to the door 8 with the lock downs 9.

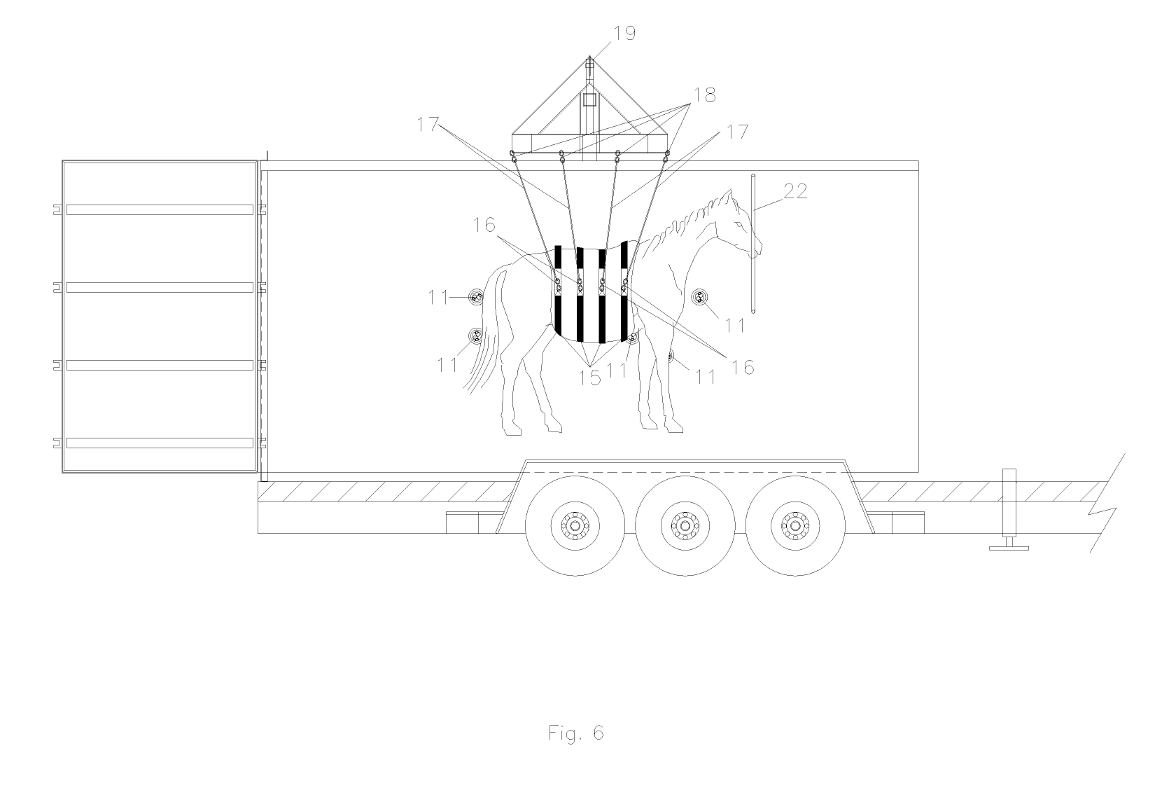

FIG. 4 shows one embodiment of a swim vest and underlying neoprene saddle pad, hereinafter referred to as the swim vest 13 which is secured to the horse using four nylon straps 14 sewn to the swim vest 13 to which vest anchor points 15 are securely affixed. FIG. 5 shows the employment of the swim vest 13 and vest anchor points 15 as they are secured by fasteners to the lift cords 16 which are then connected to the lift brace anchor points 17 which connect to a lift brace assembly 18. The structures referred to in FIG. 4 and FIG. 5 are duplicated on the far side of the horse and invention. A lift brace assembly 18 is one embodiment of a structure capable of attachment to the horse's swim vest 13. FIG. 6 shows all of the features of FIG. 5 and the lift brace assembly in a raised position which thereby raises the horse in the invention.

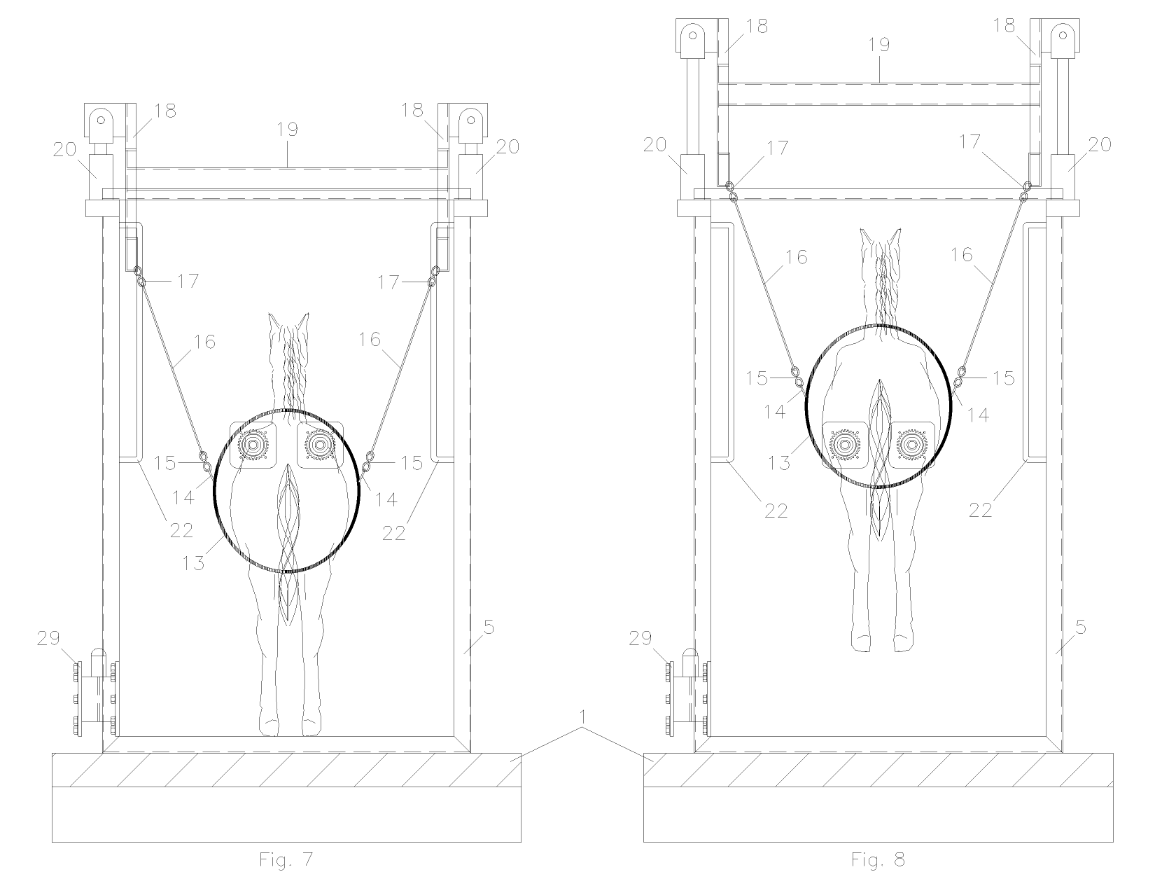

FIG. 7 shows a rear elevation view of the open swim chamber 5, a horse wearing a swim vest 13 with vest anchor points 15 connected to the lift cords 16 in turn connected to the lift brace anchor points 17 connected to the lift brace assemblies 18 which are braced together with a cross-beam reinforcement rib 19. The lift brace assemblies are each in turn connected to lifting cylinders 20 on both sides of the swim chamber 5. FIG. 8 shows the same view as FIG. 8 with the exception that the hydraulic lifting cylinders 20 are extended thereby raising the lift brace assemblies 18 which is connected to the swim vest 13, which acts to lift the horse proximately above the floor of the swim chamber 5, and above the water level of a filled swim chamber 5.

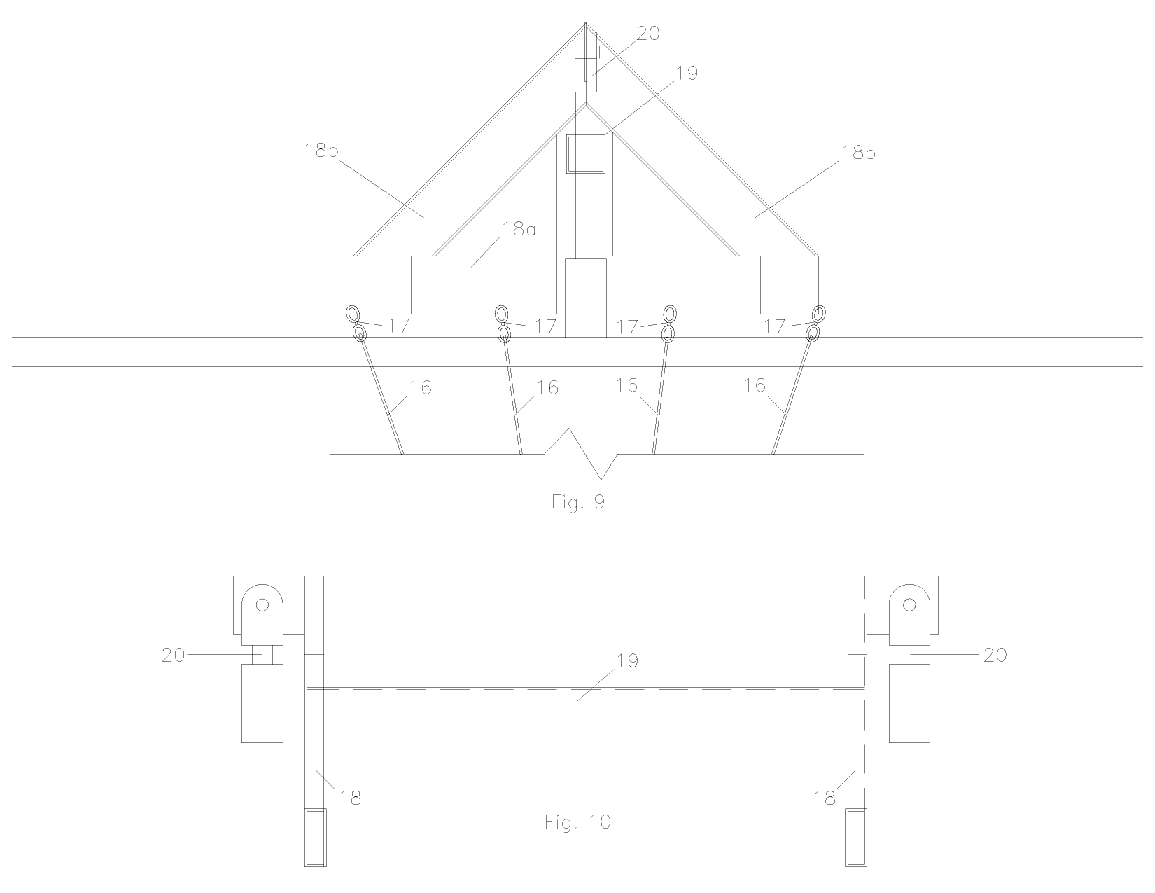

FIG. 9 shows an exploded elevation view of a lift brace assembly 18, which is comprised of a lift brace cross-member 18a, and two lift brace ribs 18b. FIG. 10 also shows the relationship between a lift brace assembly 18, lift brace assembly anchor points 17, the lift chords 16, a cross-beam reinforcement rib 19, and a lifting cylinder 20. FIG. 10 shows an exploded elevation view of the lifting assembly which is comprised of two lift brace assemblies 18, a cross-beam reinforcement rib 19, and the hydraulic lifting cylinders 20.

An exemplary hydraulic pump suitable for use as part of the lifting mechanism is a one horsepower self-contained hydraulic reservoir motor capable of raising at least 5,000 pounds vertically with the lifting cylinders. Since a typical horse will be around 1500 lbs, a 5,000 pound capacity is more than adequate. Furthermore, the exemplary hydraulic pump may use corn oil or other less irritating hydraulic fluid to reduce maintenance and to eliminate the risk of certain types of hydraulic fluid irritating the skin of the horse.

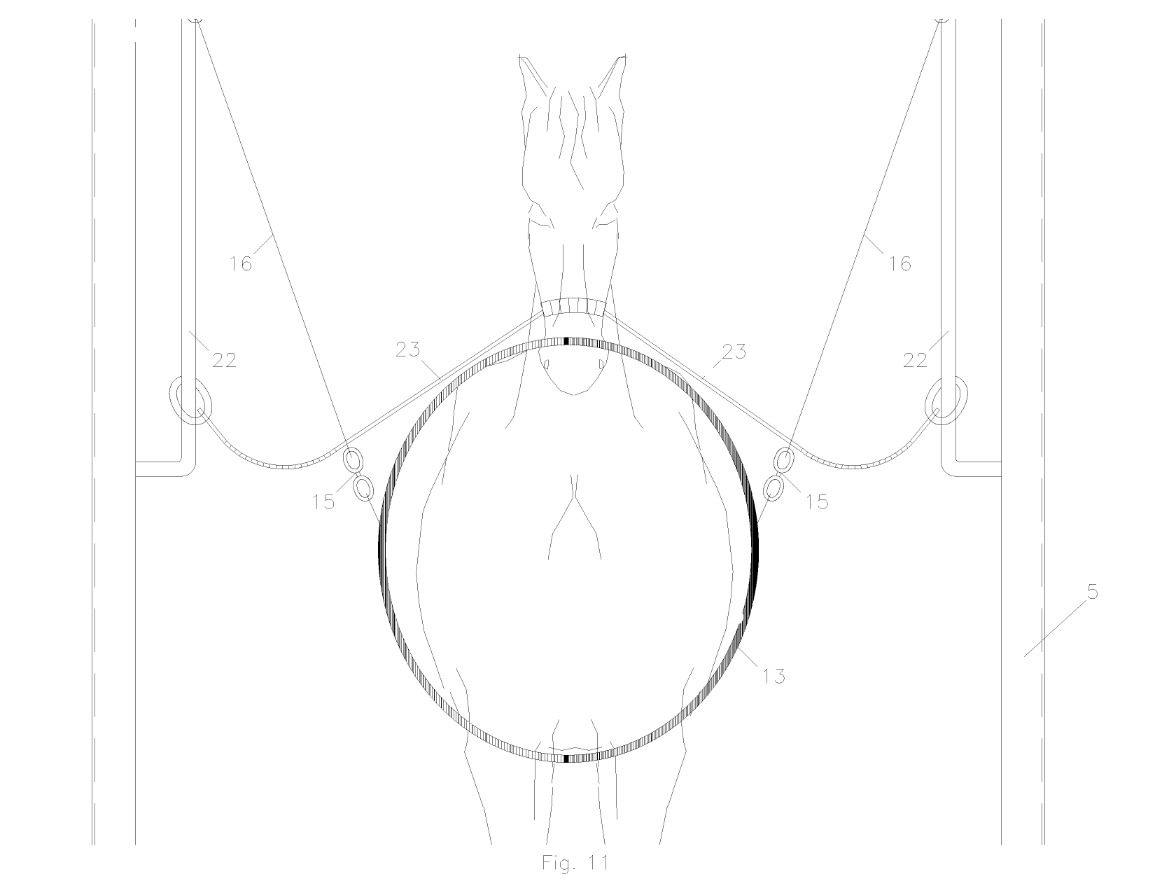

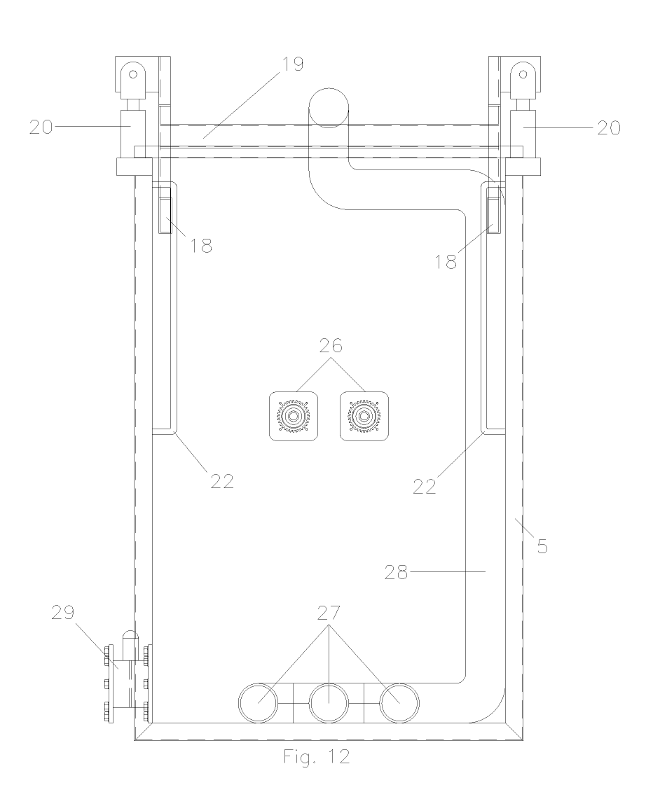

As a further refinement, and as best shown in FIG. 11, there are vertical guide rails 22 located on either side of the horse's head. Thus, side leads 23 attached to the horse's headgear can be secured to the vertical guide rails to keep the horse's head facing forward. The leads move up and down with the water and horse's head along the guide rails.

Referring now to FIGS. 1 and 2, the exemplary system also includes a motor/pump assembly 24 for transferring water from the reserve tank 4 to the swim chamber 5, and for powering the water current jets (not pictured) and massage jets (not pictured). In this exemplary embodiment, the motor/pump 24 is operably connected to the reserve tank 4 and swim chamber 5 by PVC piping 25. Hand valves 26 may be located at various sections of the PVC piping 275 controlling flow of water between the reserve tank 4 and the swim chamber 5. Although various pumps could be used without departing from the spirit and scope of the present invention, one preferred pump is a Vertiflo Series 1300 Industrial Horizontal End Suction Pump Model No. 1326 manufactured and distributed by Vertiflo Pump Company, Inc. of Cincinnati, Ohio. This pump can deliver approximately 850 gallons of water per minute, and thus takes approximately 3-4 minutes to fill the swim chamber.

FIG. 12 is a view from the aft-portion into the swim chamber 5. The view shows the current generating means, which allow the horse to swim inside the swim chamber 5. Specifically, in this exemplary embodiment, water currents are generated using twin water current jets 26 located inside the swim chamber 5 at the end opposite the door. These current jets 26 are operably connected via PVC piping (not pictured) to a water current pump (not pictured), which can deliver approximately 500 gallons of water per minute to the current jets 26, where it is forced through the current jet's rotatable nozzles which can be rotated and aimed at the chest or front legs of the horse. The current jets 26 are controllable by the operator to induce variable speeds in water current, and thus, to control the workout intensity for the horse, e.g., swim, aggressive swim, or gallop. Although various current generating means could be used without departing from the spirit and scope of the present invention, one preferred current generating means is a Badu® Stream II manufactured and distributed by Speck Pumps of Jacksonville, Fla.

FIG. 12 also demonstrates the water return system for water flow throughout the invention. The water return intakes 27 are located at the base of the swim chamber 5 and are connected to PVC return piping 28 which directs return water to the water current pump (not pictured).

As shown in FIGS. 2, 5, and 6, an exemplary system made in accordance with the present invention may also include a hydrotherapy means, for example, multiple water massage jets 11 that massage the horse. In this exemplary embodiment, water is pumped through eleven massage jets 11 located on the walls of the swim chamber on either side of the horse. The massage jets may spin to provide various water massages for different muscle groups of the horse. The massage jets are operably attached via PVC piping to a massage pump, which can deliver approximately 500 gallons of water per minute to the massage jets. Although various massage jet systems could be used without departing from the spirit and scope of the present invention, one preferred massage jet system is the Storm Jets system manufactured and distributed by Waterway Plastics of Oxnard, Calif.

In use, the horse is led up by the user up the ramp 12 and inside the swim chamber 5. The swim vest 13 will be secured to the horse already or is secured once in the swim chamber 5. The lift cords 16 are secured to the swim vest 13 and the lift brace anchor points 17. The side leads 23 are attached to the guide rails 22. The door 8 is shut using the lock downs 9. The horse will have a front lead that is retained by the user. Using a control panel, the motor/pump assembly 24 may be activated to fill the swim chamber 5 with water from the reserve tank 4. As the swim chamber 5 fills with water, the horse is raised with the hydraulic lift cylinders 20 and 315 lift brace assemblies 18 and the water current pump is started. The horse will begin swimming at this point. As described above, the current is adjusted to match the horse's conditioning and ability to swim.

Once the horse is done swimming, the current pump is shut off, the water level in the swim chamber can be adjusted and the horse can be lowered onto the floor of the swim chamber. The massage pump may then be started to provide hydrotherapy. Once the hydrotherapy is completed, the massage pump is shut off, and water in the swim chamber is pumped out of the swim chamber, through the filter, and into the reserve tank. The door is opened, the ramp is lowered, the user enters the swim chamber and unsecures the side leads from the swim vest and the horse is led down the ramp.

During an emergency situation, e.g., a sudden storm appears while the trailer is outdoors and or a horse passes out while inside the swim chamber, the user can use lift brace assembly 18 to lift the horse out of the water, as shown in FIGS. 6 and 8. Also, the motor/pump 24 can be activated to evacuate water from the swim chamber 5 into the reserve tank 4. Further, a drain valve 29, as best shown in FIG. 16, located on the outside of the swim chamber 5 allows water 330 to rapidly drain out of the swim chamber. The drain valve 29 is located at one corner of the swim chamber 5 near the end of the trailer closest to the truck. The swim chamber 5 is pitched towards the drain valve 29 to allow a majority of the water in the swim chamber 5 to exit the chamber. When the drain on the swim chamber is opened, and the motor/pump assembly is evacuating water from the swim chamber to the reserve tank, the user can have access to the horse in approximately one minute. In a round pool or swim lane, the horse must swim to the entrance/exit point or the end of the lane, respectively. For example, if a swimming lane is 100 feet long and the horse needs to be removed from the water at the 25 feet, it must first get to the end of the swimming lane 75 feet away.

To ensure the horse is exercising at an optimal level, monitoring of the horse's heart rate, breathing rate, lung capacity, etc., is possible through sensors placed on the horse. The sensors can be wireless to reduce the amount of lines that need to be attached to or from the horse. The user can then adjust the current flow and the length of swimming time based on the information provided by the sensors.

The system allows the horse to maintain its conditioning during injury without having to be transported to and from a pool, away from its trainer, and/or away from familiar surroundings. A horse that can maintain its conditioning can get back to the training faster. Also, when the horse does get back into training, its fitness level will be at a higher level due to conditioning with the system. Further, the system allows the horse to exercise without impact. There is only water resistance. There is no stressful pounding that would occur on a treadmill or some other surface.

Because there will be water around the electrical equipment, all the equipment are sealed to be water resistant. Further, there is full grounding throughout the trailer. The trailer is grounded back through the power box, as well through ground rods on-board.

One of ordinary skill in the art will also recognize that additional embodiments are possible without departing from the teachings of the present invention or the scope of the claims which follow. This detailed description, and particularly the specific details of the exemplary embodiment disclosed therein, is given primarily for clarity of understanding, and no unnecessary limitations are to be understood therefrom, for modifications will become obvious to those skilled in the art upon reading this disclosure and may be made without departing from the spirit or scope of the claimed invention.

1. A mobile horse exercise system, comprising:
a transportable trailer with a means for attachment to a towing-vehicle;
a reserve tank for holding a predetermined amount of water, said tank is placed on and secured to said trailer;
a swim chamber placed on and secured to said trailer, said swim chamber in fluid communication with said reserve tank, said swim chamber is of a size, depth and volume capable of receiving a predetermined amount of water, receiving a horse, and permitting the horse to swim;
a pump for transferring water from the reserve tank to the swim chamber;
a horse support assembly for supporting the horse during exercise;
a current generating means for directing water current towards the horse within said swim chamber;
an emergency drain valve for rapidly evacuating water from the swim chamber; and
a means for starting, stopping, controlling and varying water flow through the invention.

2. The mobile horse exercise system as recited in claim 1, and further comprising a hydrotherapy means in said swim chamber for massaging the horse.

3. The mobile horse exercise system as recited in claim 2, and wherein the hydrotherapy means is comprised of a plurality of water nozzles installed into the two lateral walls of the chamber, a pump for delivering water to the nozzles wherein said water nozzles direct water under pressure from the pump and induce torrent-jets and turbulence in the water of the swim chamber for massaging areas of the horse proximate to the effluent of the water nozzles.

4. The mobile horse exercise system as recited in claim 1, wherein the swim chamber is comprised of four walls and an open top, said wall nearest the end of the trailer is detachable such that the wall acts as a door to allow the horse to enter and exit said swim chamber, said door is fitted with a sealing means to create a water-tight seal about the door when closed and fixed to the lateral walls of the swim chamber.

5. The mobile horse exercise system as recited in claim 1, whereby the current generating means is comprised of at least two water nozzles and a pump, the combination shall be used to induce a sufficiently powerful water flow from the front of the swim chamber to the rear of the swim chamber so as to provide sufficient resistance to allow swimming in place, whereby the flow may be operably controlled to select the intensity of the water current induced in the swim chamber.
